(19) United States
(12) Patent Application Publication
(10) Pub. No.: US 2010/0111097 A1
(43) Pub. Date: May 6, 2010

(54) ADAPTIVE UTILIZATION OF A NETWORK RESPONSIVE TO A COMPETITIVE POLICY

(75) Inventors: Peter D. Karabinis, Reston, VA (US); Rajendra Singh, Indian Creek Village, FL (US)

Correspondence Address: AKERMAN SENTERFITT, P.O. BOX 3188, WEST PALM BEACH, FL, 33402-3188, US

(73) Assignee: TELCOM VENTURES, LLC, MIAMI, FL (US)

(21) Appl. No.: 12/264,714

(22) Filed: Nov. 4, 2008

(51) Int. Cl. H04J 3/16

(52) U.S. Cl. 370/437

(57) ABSTRACT

A system (10) and method (20) includes transmitting (22) Service Related (SR) data (15, 16, or 17) from each one of a plurality of networks (11, 12, and 13), receiving and processing (24) at a device (14) the SR data from each of the plurality of networks, and identifying (26) at the device a first network that satisfies a Bid Policy (BP) (19) responsive to the receiving and processing of the SR data. The identifying can be done by comparing (28) SR data with the BP. The method can then establish communications (34) preferentially with the “first network” responsive to the identifying. Note that the SR data can include terms of an offer for service including a financial term. The BP as well as the SR can have a plurality of components such as a Cost-of-Service (CoS), a Quality-of-Service (QoS), and a data rate among others.

### FIELD OF THE INVENTION

This invention relates to systems, devices and/or methods that may be used to provide an adaptive utilization of one or more communications systems/networks based upon a competitive policy. The one or more communications systems/networks may be one or more wireless and/or non-wireless communications systems/networks.

### BACKGROUND OF THE INVENTION

Those skilled in the art know that currently, a subscriber of a communications system/network is “owned” by the communications system/network in that the subscriber establishes communications using the communications system/network subject to a predetermined and agreed-upon contract that remains in effect for many months and/or years. There may even be a penalty that the subscriber may be obligated to pay in the event the subscriber decides to disengage from the predetermined and agreed-upon contract in order to receive, perhaps a more favorable, communications service from another communications system/network. Clearly, this approach is not in the best interest of the subscriber and may not even be in the best interest of any communications system/network since the current practice/approach of providing communications tends to be rigid and lacks real-time (or nearly real-time) competitive adaptivity and/or flexibility. Embodiments herein address the limitations (i.e., the rigidity) of the current practice/approach of providing communications.

As used herein, the term “end-user device” (or simply “device”) includes any electronic device that may be used to transmit/receive information wirelessly or non-wirelessly such as, for example, a Digital Subscriber Line (DSL) modem/transceiver; a cable modem/transceiver; a cellular and/or satellite radiotelephone with or without a multi-line display; Personal Communications System (PCS) terminals that may combine a radiotelephone with data processing, facsimile and/or data communications capabilities; Personal Digital Assistants (PDA) that can include a radio frequency transceiver and/or a pager, Internet/Intranet access, Web browser, organizer, calendar and/or a global positioning system (GPS) receiver; laptop and/or palmtop computers or other appliances, which may (or may not) include a radio frequency transceiver.

An end-user device also may be referred to herein as a radiotelephone, radioterminal, mobile terminal, user device, wireless device, device and/or terminal; etc. As used herein, the term end-user device and/or any of its synonyms also include(s) any other radiating device/equipment/source that may have time-varying or fixed geographic coordinates and/or may be portable, transportable, installed in a vehicle (aeronautical, maritime, or land-based) and/or situated and/or configured to operate locally and/or in a distributed fashion over one or more terrestrial and/or extra-terrestrial location(s).

### BRIEF DESCRIPTION OF THE DRAWINGS

FIG. 1 is an illustration of a wireless communication system using a Bid Policy and Service Related data in accordance with an embodiment of the present invention.

FIG. 2 is a flow chart illustrating a method of using a Bid Policy and Service Related data in accordance with an embodiment of the present invention.

### DETAILED DESCRIPTION

The present invention now will be described more fully hereinafter with reference to specific embodiments and/or the accompanying drawing(s), in which embodiments of the invention are shown. The present invention may, however, be implemented in many different forms and should not be construed as limited to the embodiments set forth herein. Rather, these embodiments are provided so that this disclosure will be thorough and complete, and will convey the scope of the various embodiments to those skilled in the art.

It will also be understood that when an element is referred to as being “connected,” “coupled” or “responsive” to another element, it can be directly connected, coupled or responsive to the other element or intervening elements may be present. Furthermore, “connected,” “coupled” or “responsive” as used herein may include wirelessly connected, coupled or responsive. The terminology used herein is for the purpose of describing particular embodiments only and is not intended to be limiting. As used herein, the singular forms “a,” “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, steps recited in the claims are not intended to imply a particular order, but rather should be understood as being one among any number of steps that may be performed in any particular order and with or without additional steps.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Furthermore, it will be understood that although terms such as, for example, first and second may be used herein to describe various elements, these elements should not be limited by these terms. These terms are only used to distinguish one element from another element. Thus, a first element below could be termed a second element, and similarly, a second element may be termed a first element without departing from the teachings of the present invention. As used herein, the term “and/or” includes any and all combinations of one or more of the associated listed items. The symbol “/” is also used as a shorthand notation for “and/or.”

Embodiments herein address the rigidity of the current practice/approach of providing communications. Accordingly, embodiments of the present invention provide systems, devices and/or methods that may be used to enable an adaptive utilization of one or more communications systems/networks based upon a competitive policy that may be advantageous and, according to some embodiments of the present invention, maximally (or near maximally) advantageous for the subscriber/user of the one or more communications systems/networks from a financial perspective, from a perspective relating to a Quality-of-Service (QoS), from a perspective of data throughput and/or from a perspective relating to a user experience. Also, embodiments herein provide systems, devices and/or methods that may be used to enable an adaptive utilization of one or more communications systems/networks based upon a competitive policy that may be advantageous and, according to some embodiments of the present invention, maximally (or near maximally) advantageous for the one or more communications systems/networks from a financial perspective, from a perspective relating to a Quality-of-Service (QoS), from a perspective of data throughput and/or from a perspective relating to a user experience.

One or more networks, that may, according to some embodiments of the present invention, comprise one or more wireless networks, may be configured to transmit Service Related (SR) data providing terms of an offer for service, wherein the terms may include a financial term. A device, that may be a wireless device such as, for example, a wireless terminal, a Personal Digital Assistant (PDA), a wireless/mobile phone, a smart phone, a multi-media device including Global Positioning System (GPS) capability, etc., may be configured to receive and process the SR data from the one or more networks and to identify, responsive to having received and processed the SR data, a first network, of the one or more networks, that satisfies a Bid Policy (BP) of the device. The BP may reside at the device and may comprise conditions under which the device may be willing to accept service from a network. Having identified the first network as one which satisfies the BP, the device may establish communications preferentially with the first network. Accordingly, the device may provide a signal to the first network indicating that the device desires to receive and/or establish/transmit communications via the first network and/or indicating that the SR data of the first network is acceptable to the device (i.e., the device and the network negotiate/establish a “contract” based upon (subject to) the SR data that has been provided by the network and based upon (subject to) the BP of the device).

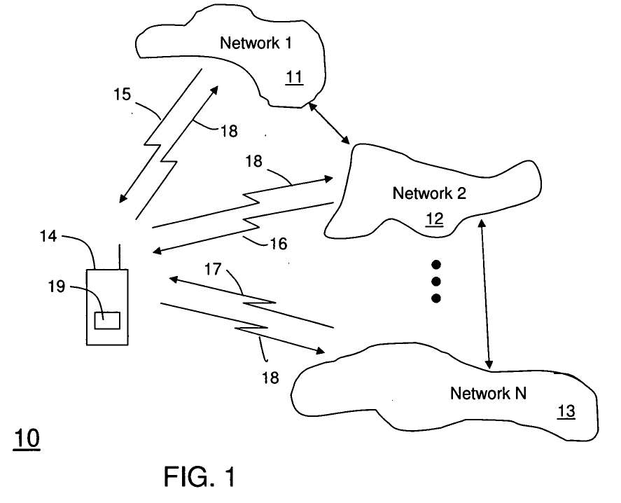

FIG. 1 is illustrative of systems and devices that may be provided in accordance with the present invention. For example, an embodiment can include a wireless communication system 10 having a plurality of networks (1 through N) 11, 12, and 13 that are operatively coupled to one or more wireless communication or subscriber devices 14. Only one subscriber device is shown for simplicity. Each of the subscriber devices 14 can have a Bid Policy (BP) 19. The BP can be stored locally in a memory of the device or in another location (remote or otherwise) accessible to the device. Each of the networks 11, 12, and 13 may be configured to have and transmit a respective Service Related (SR) data 15, 16, and 17. The subscriber device 14 can send a signal 18 to a corresponding network indicative that the SR data is acceptable (or not) in view of the BP 19, whereupon communication between the subscriber device 14 and a network of preference within the scope of the BP 19 will commence communication.

Based on the principles disclosed above, many embodiments of the present invention relating to systems, devices and/or methods may be provided. For example, according to some embodiments of the present invention, a communications method may be provided comprising: receiving and/or processing at a device, that may, according to some embodiments, comprise a wireless communications device, Service Related (SR) data from each one of a plurality of networks (wherein the plurality of networks may comprise, according to some embodiments of the present invention, a plurality of wireless communications networks); identifying responsive to the receiving and/or processing a first network, of the plurality of networks, that satisfies a Bid Policy (BP) that may, according to some embodiments of the present invention, comprise a BP associated with the device; and establishing communications (receiving and/or transmitting) preferentially with the first network responsive to the identifying; wherein, according to some embodiments of the present invention, the SR data comprises terms of an offer for service, including a financial term.

In accordance with other embodiments, the BP comprises a plurality of components and according to some embodiments, at least one of the components may be associated with a priority level indicating a level of importance for the at least one of the components. In further embodiments of the present invention, the plurality of components comprises a Cost-of-Service (CoS), a Quality-of-Service (QoS), a data rate, a vocoder quality, a vocoder data rate and/or a service latency. It will be understood that the term “identifying,” as used herein comprises, in accordance with some embodiments, comparing the SR data with the BP.

In further embodiments of the present invention, the BP may, at least partially, be determined by a user of a device and/or by a manufacturer of the device and the BP, may, in accordance with some embodiments, be position dependent and/or Time-of-Day (ToD) dependent. In other embodiments, the SR data comprises a plurality of components such as, for example, a Cost-of-Service (CoS), a Quality-of-Service (QoS), a data rate, a vocoder quality, a vocoder data rate and/or a service latency.

In some embodiments, the identifying is performed once or a plurality of times over a time interval, wherein the time interval may be fixed or variable, and the time interval may be determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) and/or a latency. In some embodiments, the mode of communications comprises a voice mode, a data mode and/or a multi-media mode, wherein the multi-media mode may comprise audio and video information and/or voice and data information.

In further embodiments, the first network comprises at least two networks, wherein a first one of the at least two networks is used to establish voice communications with the device and wherein a second one of the at least two networks is used to establish data communications with the device. In some embodiments, a first one of the at least two networks uses a first protocol to communicate with the device and a second one of the at least two networks uses a second protocol to communicate with the device, wherein the first protocol may be substantially the same as the second protocol or, according to some embodiments, the first protocol may differ from the second protocol.

Similarly, according to some embodiments, the device uses a first protocol to communicate with a first one of the at least two networks and the device uses a second protocol to communicate with a second one of the at least two networks, wherein the first protocol may be substantially the same as the second protocol or, according to other embodiments, the first protocol may differ from the second protocol. In further embodiments, the first protocol uses a first frequency band and the second protocol uses a second frequency band. In some embodiments, establishing communications comprises establishing communications with a first one of the at least two networks and with a second one of the at least two networks. According to some embodiments, the device comprises a multi-band and/or multi-mode capability and in further embodiments, the device is a Software-Defined Radio (SDR) device, according to SDR technologies known to those skilled in the art.

In accordance with some embodiments of the present invention, the term multi-band, as used herein, comprises a band of frequencies that is authorized/licensed for use in providing space-based communications, a band of frequencies that is authorized and/or licensed for use in providing terrestrially-based communications and/or an unlicensed band of frequencies and the term multi-mode, as used herein, comprises a mode that is used to provide space-based voice and/or data communications and/or a mode that is used to provide terrestrially-based voice and/or data communications. In any one of the embodiments of the present invention as described above, or to be described below, it will be understood that the device may comprise a plurality of Power Amplifiers (PAs) and/or a plurality of Low Noise Amplifiers (LNAs), as necessary, to address and/or accommodate a multi-band configuration thereof.

According to other embodiments, a method is provided comprising: transmitting from a network Service Related (SR) data; receiving at the network responsive to the transmitting a signal from a device indicating that a Bid Policy (BP) that is associated with the device is satisfied by the SR data; and establishing by the network a communications link with the device responsive to the receiving; wherein the SR data comprises terms of an offer for service including a financial term. As has been already stated with respect to some embodiments, the BP may comprise a plurality of components, and, according to some embodiments, the SR data may depend on Time-of-Day (ToD) whereby the SR data changes at least once during a 24-hour time interval. In some embodiments, a financial term associated with the SR data reflects a higher charge during a busy hour and/or during an event representing network congestion. During the busy hour and/or during the event representing network congestion, the BP may also reflect a higher level of acceptance regarding a financial term for acquiring service (i.e., one may be willing to pay more to communicate during the busy hour and/or during the event representing network congestion). In some embodiments, at least some of a plurality of devices (e.g., at least some of a plurality of wireless communications devices) may be configured to transmit, once or repeatedly, their respective Bid Policies (BPs) and one or more networks may be configured to receive and process the BPs and, according to some embodiments, modify/alter/change their respective SR data responsive to the received BPs. For example, a network that decides to provide more favorable terms of an offer for service, financially or otherwise, responsive to having received and having processed at least some of the BPs, may be able to negotiate more customers.

As already stated with respect to some embodiments, a BP may comprise a plurality of components comprising a Cost-of-Service (CoS), a Quality-of-Service (QoS), a data rate, a vocoder quality, a vocoder data rate and/or a service latency and the device may, according to some embodiments, be configured to perform a comparison between the SR data and the BP and transmit a signal, requesting service, responsive to the comparison if the BP is satisfied by the SR data. The BP may be determined at least partially by a user of the device and/or by a manufacturer of the device and may, in accordance with some embodiments, be position dependent and/or Time-of-Day (ToD) dependent. For example, a device may be able to determine (at least approximately) its position and/or ToD. As such, if, for example, the position and/or the ToD that the device determines requires that, for example, the device be able to communicate even at a high cost (or at any cost) then the BP of the device may be adjusted accordingly.

In some embodiments, transmitting from a network the SR data is performed once or a plurality of times over a time interval and receiving at the network responsive to the transmitting may comprise receiving first and second signals from respective first and second devices and establishing by the network a communications link may comprise establishing first and second communications links with the first and second devices, respectively, wherein each one of the first and second communications links may comprise a voice mode, a data mode and/or a multi-media mode. The multi-media mode may comprise audio and video information and/or voice and data information. In further embodiments, the first communications link comprises a first protocol and the second communications link comprises a second protocol that differs from the first protocol. In other embodiments, the first communications link comprises a first frequency band and the second communications link comprises a second frequency band that differs from the first frequency band. In accordance with some embodiments, establishing by the network a communications link with the device comprises establishing first and second communications links with the device over respective first and second frequency bands, wherein the first communications link may be used for voice communications and the second communications link may be used for data communications. In accordance with some embodiments, at least one of the first and second frequency bands comprises frequencies of an unlicensed frequency band.

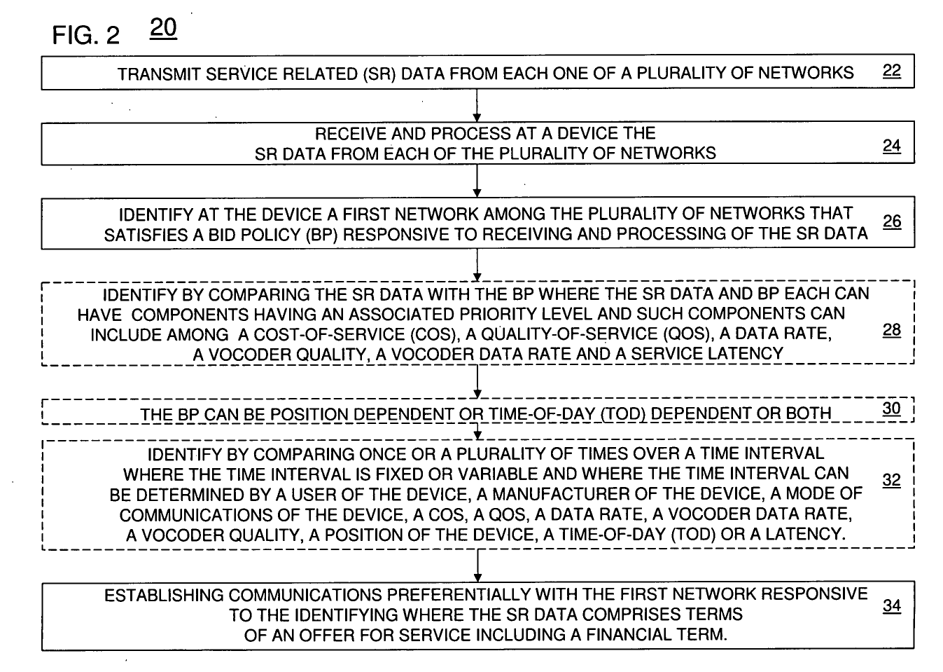

As an exemplary illustration, a flow chart depicting a method 20 is shown in FIG. 2. The method 20 can include transmitting Service Related (SR) data from each one of a plurality of networks at 22, receiving and processing at a device the SR data from each of the plurality of networks at 24, and identifying at the device a first network among the plurality of networks that satisfies a Bid Policy (BP) responsive to the receiving and processing of the SR data at 26. Note that the step of identifying at 26 a “first network” that satisfies the BP can literally mean the very first network that satisfies the BP or can also be interpreted to mean a first network among a predetermined number of networks that satisfies the BP to an extent most favorable to the user of the device relative to all the networks being compared. The method can then establish communications preferentially with the “first network” responsive to the identifying at 34. Note that the SR data can include terms of an offer for service including a financial term.

The method 20 can include the step of comparing the SR data with the BP at 28. The BP as well as the SR can have a plurality of components. Also note that the components of the BP can be associated with a priority level. Further note that the plurality of components can include all or some among the components including a Cost-of-Service (CoS), a Quality-of-Service (QoS), a data rate, a vocoder quality, a vocoder data rate and a service latency. As noted in step 30, the BP can be position dependent or Time-of-Day (ToD) dependent or both. At step 32, the step of identifying by comparing can be done once or a plurality of times over a time interval where the time interval is fixed or variable and where the time interval can be determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) or a latency or any combination thereof. The mode of communications can be a voice mode, a data mode and/or a multi-media mode. The device may be configured to have a multi-band capability and/or a multi-mode capability and the device can be a Software-Defined Radio (SDR) device. In the case of a multi-band radio, the multi-band can include a band of frequencies that is authorized/licensed for use in providing space-based communications, a band of frequencies that is authorized/licensed for use in providing terrestrially-based communications and/or an unlicensed band of frequencies. In the case of a multi-mode radio, a first mode can be used to provide space-based voice and/or data communications and a second mode may be used to provide terrestrially-based voice and/or data communications. A third mode may also be provided that is a combination of the first and second modes.

In yet other embodiments, a system may be provided comprising: a device that is configured to receive and process Service Related (SR) data from each one of a plurality of networks; to identify, responsive to having received and processed the SR data, a first network, of the plurality of networks, that satisfies a Bid Policy (BP) of the device; and to establish communications preferentially with the first network responsive to the first network having satisfied the BP; wherein the SR data comprises terms of an offer for service and includes a financial term.

In further embodiments, the BP comprises a plurality of components, wherein at least one of the components may be associated with a priority level. The plurality of components, according to some embodiments, comprises a Cost-of-Service (CoS), a Quality-of-Service (QoS), a data rate, a vocoder quality, a vocoder data rate and/or a service latency and the device may be configured to identify the first network by comparing the SR data with the BP. The BP may, at least partially, be determined by a user of the device and/or by a manufacturer of the device and, in some embodiments of the invention, the BP may be position dependent and/or Time-of-Day (ToD) dependent. In further embodiments, the SR data may comprise a plurality of components, wherein the plurality of components may comprise a Cost-of-Service (CoS), a Quality-of-Service (QoS), a data rate, a vocoder quality, a vocoder data rate and/or a service latency.

According to some embodiments, the device may be configured to identify the first network once or a plurality of times over a time interval, wherein the time interval may be fixed or variable. In some embodiments of the invention, the time interval is determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) and/or a latency; wherein the mode of communications may be a voice mode, a data mode and/or a multi-media mode and wherein the multi-media mode may comprise audio and video information and/or voice and data information.

In further embodiments, the first network comprises at least two networks, wherein a first one of the at least two networks may be used to establish voice communications with the device and wherein a second one of the at least two networks may be used to establish data communications with the device. In other embodiments, a first one of the at least two networks uses a first protocol to communicate with the device and a second one of the at least two networks uses a second protocol to communicate with the device, wherein the first protocol may be substantially the same as the second protocol or may differ from the second protocol. In some further embodiments, the device uses a first protocol to communicate with a first one of the at least two networks and the device uses a second protocol to communicate with a second one of the at least two networks, wherein the first protocol may be substantially the same as the second protocol or may differ from the second protocol.

In some embodiments, the first protocol uses a first frequency band and the second protocol uses a second frequency band. In further embodiments, the device establishes communications preferentially with a first one of the at least two networks and with a second one of the at least two networks. In some embodiments, the device comprises a multi-band and/or multi-mode capability and in some other embodiments, the device comprises a Software-Defined Radio (SDR) device. The term “multi-band” as used herein comprises a band of frequencies that is authorized and/or licensed for the provision of space-based communications, a band of frequencies that is authorized and/or licensed for use in providing terrestrially-based communications and/or an unlicensed band of frequencies. Furthermore, the term “multi-mode” as used herein comprises a mode that is used to provide space-based voice and/or data communications, and/or a mode that is used to provide terrestrially-based voice and/or data communications. The device, which may be a wireless communications device that is fixed, mobile, wireless, land-based, for military use, for commercial/civilian use, maritime, aeronautical, located substantially in one place, and/or distributed in space, may comprise a plurality of antenna elements a plurality of Power Amplifiers (PAs) and/or a plurality of Low Noise Amplifiers (LNAs). Similarly, the network, which may be a wireless communications network, may comprise a plurality of antenna elements a plurality of Power Amplifiers (PAs) and/or a plurality of Low Noise Amplifiers (LNAs). The plurality of antenna elements may be substantially co-located or may be distributed in space to provide additional diversity reception and/or transmission capability for the network. Diversity reception/transmission may also be provided, in some embodiments, by configuring one or more of the antenna elements to receive/transmit over two or more different polarizations which, in some embodiments, may be substantially orthogonal therebetween.

In additional embodiments, a system is provided comprising: a network that is configured to transmit Service Related (SR) data; to receive from a device, responsive to the transmitted SR data, a signal indicating that a Bid Policy (BP) of the device is satisfied by the SR data; and to establish a communications link with the device responsive to having received the signal; wherein the SR data comprises terms of an offer for service and includes a financial term.

The BP may comprise a plurality of components and the SR data may depend on Time-of-Day (ToD). The plurality of components may comprise a Cost-of-Service (CoS), a Quality-of-Service (QoS), a data rate, a vocoder quality, a vocoder data rate and/or a service latency. In some embodiments, the device may be configured to perform a comparison between the SR data and the BP and transmit the signal responsive to the comparison if the BP is satisfied by the SR data. The BP may be determined, at least partially, by a user of the device and/or by a manufacturer of the device and the signal may comprise a request for service. Further, the BP may be position dependent and/or Time-of-Day (ToD) dependent and the network may be configured to transmit the SR data once or a plurality of times over a time interval.

In some embodiments, the signal comprises first and second signals from respective first and second devices and the network is configured to establish first and second communications links with the first and second devices, respectively. Each one of the first and second communications links may comprise a voice mode, a data mode and/or a multi-media mode. The multi-media mode may comprise audio and video information and/or voice and data information. The first communications link may comprise a first protocol and the second communications link may comprise a second protocol that differs from the first protocol. Further, the first communications link may comprise a first frequency band and the second communications link may comprise a second frequency band that differs from the first frequency band.

In some embodiments, the communications link comprises first and second communications links over respective first and second frequency bands, wherein the first communications link may be used for voice communications and the second communications link may be used for data communications. In further embodiments, at least one of the first and second frequency bands comprises frequencies of an unlicensed frequency band. In any of the systems and/or methods embodiments described herein and in any combination and/or permutation thereof, it will be understood that the term “network” may comprise a wireless network and/or a wireline network and that the term “device” may comprise a wireless communications device and/or a wireline communications device. It will also be understood that any of the parameters/quantities discussed herein, including the SR data (i.e., any component thereof) may depend on ToD and may also depend on a business/financial concern that may be associated with the network.

In some embodiments, a plurality of networks may be configured to exchange data (i.e., communicate and/or be inter-connected) therebetween so as to allow a level of coordination in using and/or reusing frequencies therebetween. In other embodiments, the plurality of networks that may be configured to exchange data may allow for handing over of a call, data session and/or a multi-media session, that is being conducted (uni-directionally or bi-directionally) between a device and a first network, of the plurality of networks, from the first network to a second network of the plurality of networks. The handing over may be responsive, in some embodiments, to the device having negotiated a more favorable service provision (financially-speaking and/or otherwise) with the second network. As such, the device may initiate the handing over from the first network to the second network by informing the first and second networks of its decision.

Each network of the plurality of networks may be configured to keep a record of service provided to a device. In some embodiments, each network of the plurality of networks transmits the record of service to the device to a Central Processing Facility (CPF), for example, once per month. The CPF may be configured to aggregate a record of service provided to a device by, for example, a first network, with a record of service provided to the device by, for example, a second network, etc. and to provide an aggregated record to a user of the device for review/information and/or for payment of any financial obligation thereof. The CPF may be configured to collect a payment from the user of the device and to apportion the payment to the first, second, etc. networks, in accordance with respective records of service provided to the device associated with the first, second, etc. networks, respectively.

In some embodiments, the plurality of networks may be configured to exchange data (i.e., communicate and/or be inter-connected) therebetween in order to provide a more reliable/robust/redundant/secure service by allowing for intra-network interleaving of data, thus providing intra-network diversity. Also, in lieu of the interleaving of data, transporting data simultaneously over two or more networks, of the plurality of networks, may be used to provide added reliability/robustness/redundancy/diversity/security. In further embodiments, intra-network interleaving may be used in combination with transporting data simultaneously over two or more networks. An algorithm that, in some embodiments, may be a pseudo-random algorithm may be used to control aspects of the intra-network interleaving and/or the transporting data simultaneously over two or more networks.

According to additional embodiments, a network-to-network bidding for resources may take place. A network, either for its own user(s) and/or for Visitor User(s) may bid for resources from one or more other networks for congestion relief, grade-of-service improvement(s) and/or for one or more other service quality reason(s). For example, a network may take on one or more Visitor Users while the network's Home Users continue to need/consume resources that may need to be allocated to accommodate the one or more Visitor Users. In this case, the network may bid for resources (e.g., frequencies, personal data, user profile/preferences, etc.) from one or more other networks in order to accommodate the one or more Visitor Users while maintaining an acceptable quality of service for the network's Home Users that are currently being served or are expected to be served.

In the specification, there have been disclosed embodiments of the invention and, although specific terms are employed, they are used in a generic and descriptive sense only and not for purposes of limitation. The following claims are provided to set forth, at least in part, the scope of the embodiments.

1. A method comprising:
receiving and processing at a device Service Related (SR) data from each one of a plurality of networks;
identifying a first network among the plurality of networks that satisfies a Bid Policy (BP) responsive to the receiving and processing of the SR data; and
establishing communications preferentially with the first network responsive to the identifying;
wherein the SR data comprises terms of an offer for service including a financial term.

2. The method according to claim 1, wherein the BP comprises a plurality of components.

3. The method according to claim 2, wherein at least one of the components is associated with a priority level.

4. The method according to claim 2, wherein the plurality of components comprises a Cost-of-Service (CoS), a Quality-of-Service (QoS), a data rate, a vocoder quality, a vocoder data rate and/or a service latency.

5. The method according to claim 1, wherein identifying comprises comparing the SR data with the BP.

6. The method according to claim 5, wherein the BP is at least partially determined by a user of a device and/or by a manufacturer of the device.

7. The method according to claim 5, wherein the BP is position dependent or Time-of-Day (ToD) dependent or both.

8. The method according to claim 1, wherein the SR data comprises a plurality of components.

9. The method according to claim 8, wherein the plurality of components comprises a Cost-of-Service (CoS), a Quality-of-Service (QoS), a data rate, a vocoder quality, a vocoder data rate and/or a service latency.

10. The method according to claim 1, wherein identifying is performed once or a plurality of times over a time interval.

11. The method according to claim 1, wherein identifying is performed once or a plurality of times over a time interval where the time interval is fixed or variable.

12. The method according to claim 11, wherein the time interval is determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) and/oror a latency.

13. The method according to claim 12, wherein the mode of communications comprises a voice mode, a data mode and/or a multi-media mode.

14. The method according to claim 13, wherein the multi-media mode comprises audio and video information and/or voice and data information.

15. The method according to claim 1, wherein the first network comprises at least two networks.

16. The method according to claim 15, wherein a first one of the at least two networks is used to establish voice communications with the device and wherein a second one of the at least two networks is used to establish data communications with the device.

17. The method according to claim 15, wherein a first one of the at least two networks uses a first protocol to communicate with the device and a second one of the at least two networks uses a second protocol to communicate with the device.

18. The method according to claim 17, wherein the first protocol is substantially the same as the second protocol.

19. The method according to claim 17, wherein the first protocol differs from the second protocol.

20. The method according to claim 15, wherein the device uses a first protocol to communicate with a first one of the at least two networks and wherein the device uses a second protocol to communicate with a second one of the at least two networks.

21. The method according to claim 20, wherein the first protocol is substantially the same as the second protocol.

22. The method according to claim 20, wherein the first protocol differs from the second protocol.

23. The method according to claim 20, wherein the first protocol uses a first frequency band and wherein the second protocol uses a second frequency band.

24. The method according to claim 17, wherein the first protocol uses a first frequency band and wherein the second protocol uses a second frequency band.

25. The method according to claim 15, wherein establishing communications comprises establishing communications with a first one of the at least two networks and with a second one of the at least two networks.

26. The method according to claim 1, wherein the device comprises a multi-band and/or multi-mode capability.

27. The method according to claim 26, wherein the device is a Software-Defined Radio (SDR) device.

28. The method according to claim 26, wherein multi-band comprises a band of frequencies that is authorized/licensed for use in providing space-based communications, a band of frequencies that is authorized/licensed for use in providing terrestrially-based communications and/or an unlicensed band of frequencies.

29. The method according to claim 28, wherein multi-mode comprises a mode that is used to provide space-based voice and/or data communications and/or a mode that is used to provide terrestrially-based voice and/or data communications.

30. The method according to claim 26, wherein the device comprises a plurality of Power Amplifiers (PAs) and/or a plurality of Low Noise Amplifiers (LNAs).

31. The method according to claim 1, wherein the SR data depends on Time-of-Day (ToD).

32. A method comprising:
transmitting from a network Service Related (SR) data;
receiving at the network a signal from a device indicating that a Bid Policy (BP) that is associated with the device is satisfied by the SR data responsive to the transmitting of the SR data; and
establishing by the network a communications link with the device responsive to the receiving;
wherein the SR data comprises terms of an offer for service including a financial term.

33. The method according to claim 32, wherein the BP comprises a plurality of components having a Cost-of-Service (CoS), a Quality-of-Service (QoS), a data rate, a vocoder quality, a vocoder data rate or a service latency.

34. The method according to claim 32, wherein the SR data depends on Time-of-Day (ToD).

35. The method according to claim 33, wherein the plurality of components comprises a Cost-of-Service (CoS), a Quality-of-Service (QoS), a data rate, a vocoder quality, a vocoder data rate and a service latency.

36. The method according to claim 32, wherein the device performs a comparison between the SR data and the BP and transmits the signal responsive to the comparison if the BP is satisfied by the SR data.

37. The method according to claim 36, wherein the BP is determined at least partially by a user of the device and/or by a manufacturer of the device.

38. The method according to claim 32, wherein the signal comprises a request for service.

39. The method according to claim 35, wherein the BP is position dependent or Time-of-Day (ToD) dependent or both.

40. The method according to claim 32, wherein transmitting is performed once or a plurality of times over a time interval.

41. The method according to claim 32, wherein receiving comprises receiving first and second signals from respective first and second devices and wherein establishing comprises establishing first and second communications links with the first and second devices, respectively.

42. The method according to claim 41, wherein each one of the first and second communications links comprises a voice mode, a data mode and/or a multi-media mode.

43. The method according to claim 42, wherein the multi-media mode comprises audio and video information and/or voice and data information.

44. The method according to claim 42, wherein the first communications link comprises a first protocol and the second communications link comprises a second protocol that differs from the first protocol.

45. The method according to claim 42, wherein the first communications link comprises a first frequency band and the second communications link comprises a second frequency band that differs from the first frequency band.

46. The method according to claim 32, wherein establishing by the network a communications link with the device comprises establishing first and second communications links with the device over respective first and second frequency bands.

47. The method according to claim 46, wherein the first communications link is used for voice communications and the second communications link is used for data communications.

48. The method according to claim 46, wherein at least one of the first and second frequency bands comprises frequencies of an unlicensed frequency band.

49. The system comprising:
a device that is configured to receive and process Service Related (SR) data from each one of a plurality of networks; to identify, responsive to having received and processed the SR data, a first network, of the plurality of networks, that satisfies a Bid Policy (BP) of the device; and to establish communications preferentially with the first network responsive to the first network having satisfied the BP;
wherein the SR data comprises terms of an offer for service and includes a financial term.

50. The system according to claim 49, wherein the SR data depends on Time-of-Day (ToD).

51. The system according to claim 50, wherein the BP comprises a plurality of components having a Cost-of-Service (CoS), a Quality-of-Service (QoS), a data rate, a vocoder quality, a vocoder data rate or a service latency.

52. The system according to claim 51, wherein at least one of the components is associated with a priority level.

53. The system according to claim 51, wherein the plurality of components comprises a Cost-of-Service (CoS), a Quality-of-Service (QoS), a data rate, a vocoder quality, a vocoder data rate and/or a service latency.

54. The system according to claim 50, wherein the device is configured to identify the first network by comparing the SR data with the BP.

55. The system according to claim 54, wherein the BP is at least partially determined by a user of the device or by a manufacturer of the device.

56. The system according to claim 54, wherein the BP is position dependent and/or Time-of-Day (ToD) dependent.

57. The system according to claim 50, wherein the SR data comprises a plurality of components having a Cost-of-Service (CoS), a Quality-of-Service (QoS), a data rate, a vocoder quality, a vocoder data rate or a service latency.

58. The system according to claim 57, wherein the plurality of components comprises a Cost-of-Service (CoS), a Quality-of-Service (QoS), a data rate, a vocoder quality, a vocoder data rate and/or a service latency.

59. The system according to claim 50, wherein the device is configured to identify the first network once or a plurality of times over a time interval.

60. The system according to claim 59, wherein the time interval is fixed or variable.

61. The system according to claim 60, wherein the time interval is determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) and/or a latency.

62. The system according to claim 61, wherein the mode of communications is a voice mode, a data mode and/or a multi-media mode.

63. The system according to claim 62, wherein the multi-media mode comprises audio and video information and/or voice and data information.

64. The system according to claim 50, wherein the first network comprises at least two networks.

65. The system according to claim 64, wherein a first one of the at least two networks is used to establish voice communications with the device and wherein a second one of the at least two networks is used to establish data communications with the device.

66. The system according to claim 64, wherein a first one of the at least two networks uses a first protocol to communicate with the device and a second one of the at least two networks uses a second protocol to communicate with the device.

67. The system according to claim 66, wherein the first protocol is substantially the same as the second protocol.

68. The system according to claim 66, wherein the first protocol differs from the second protocol.

69. The system according to claim 64, wherein the device uses a first protocol to communicate with a first one of the at least two networks and wherein the device uses a second protocol to communicate with a second one of the at least two networks.

70. The system according to claim 69, wherein the first protocol is substantially the same as the second protocol.

71. The system according to claim 69, wherein the first protocol differs from the second protocol.

72. The system according to claim 69, wherein the first protocol uses a first frequency band and wherein the second protocol uses a second frequency band.

73. The system according to claim 66, wherein the first protocol uses a first frequency band and wherein the second protocol uses a second frequency band.

74. The system according to claim 64, wherein the device establishes communications preferentially with a first one of the at least two networks and with a second one of the at least two networks.

75. The system according to claim 50, wherein the device comprises a multi-band and/or multi-mode capability.

76. The system according to claim 75, wherein the device is a Software-Defined Radio (SDR) device.

77. The system according to claim 75, wherein multi-band comprises a band of frequencies that is authorized/licensed for use in providing space-based communications, a band of frequencies that is authorized/licensed for use in providing terrestrially-based communications and/or an unlicensed band of frequencies.

78. The system according to claim 77, wherein multi-mode comprises a mode that is used to provide space-based voice and/or data communications, and/or a mode that is used to provide terrestrially-based voice and/or data communications.

79. The system according to claim 75, wherein the device comprises a plurality of Power Amplifiers (PAs) and/or a plurality of Low Noise Amplifiers (LNAs).

80. A system comprising:
a network that is configured to:
transmit Service Related (SR) data to a device;
receive from the device a signal indicating that a Bid Policy (BP) of the device is satisfied by the SR data responsive to the transmitted SR data; and
establish a communications link with the device responsive to having received the signal indicating that the BP is satisfied by the SR data;
wherein the SR data comprises terms of an offer for service and includes a financial term.

81. The system according to claim 80, wherein the BP comprises a plurality of components including a Cost-of-Service (CoS), a Quality-of-Service (QoS), a data rate, a vocoder quality, a vocoder data rate and/or a service latency.

82. The system according to claim 80, wherein the SR data depends on Time-of-Day (ToD).

83. The system according to claim 80, wherein the device performs a comparison between the SR data and the BP and transmits the signal responsive to the comparison if the BP is satisfied by the SR data.

84. The system according to claim 83, wherein the BP is determined at least partially by a user of the device and/or by a manufacturer of the device.

85. The system according to claim 80, wherein the signal comprises a request for service.

86. The system according to claim 83, wherein the BP is position dependent and/or Time-of-Day (ToD) dependent.

87. The system according to claim 80, wherein the network is configured to transmit the SR data once or a plurality of times over a time interval.

88. The system according to claim 80, wherein the signal comprises first and second signals from respective first and second devices and wherein the network is configured to establish first and second communications links with the first and second devices, respectively.

89. The system according to claim 88, wherein each one of the first and second communications links comprises a voice mode, a data mode and/or a multi-media mode.

90. The system according to claim 89, wherein the multi-media mode comprises audio and video information and/or voice and data information.

91. The system according to claim 89, wherein the first communications link comprises a first protocol and the second communications link comprises a second protocol that differs from the first protocol.

92. The system according to claim 89, wherein the first communications link comprises a first frequency band and the second communications link comprises a second frequency band that differs from the first frequency band.

93. The system according to claim 82, wherein the communications link comprises first and second communications links over respective first and second frequency bands.

94. The system according to claim 93, wherein the first communications link is used for voice communications and the second communications link is used for data communications.

95. The system according to claim 93, wherein at least one of the first and second frequency bands comprises frequencies of an unlicensed frequency band.

96. The system according to claim 80, wherein the network comprises a wireless network and the device comprises a wireless device.

97. A system comprising:
a wireless network that is configured to:
transmit Service Related (SR) data to a wireless subscriber device;
perform at the wireless subscriber device a comparison between the SR data and a Bid Policy (BP) of the wireless subscriber device and generate a signal responsive to the comparison if the BP is satisfied by the SR data;
receive from the wireless subscriber device the signal indicating that a Bid Policy (BP) of the wireless subscriber device is satisfied by the SR data responsive to the transmitted SR data; and
establish a communications link with the device responsive to having received the signal indicating that the BP is satisfied by the SR data;
wherein the SR data comprises terms of an offer for service and wherein the BP and SR data both include at least a Cost-of-Service (CoS), a Quality-of-Service (QoS), and a data rate.

98. The system according to claim 97, wherein performing the comparison occurs over a time interval determined by a user of the device, a manufacturer of the device, a mode of communications of the device, a Cost-of-Service (CoS), a Quality-of-Service (QoS), a data rate, a vocoder data rate, a vocoder quality, a position of the device, a Time-of-Day (ToD) or a latency.
